(19) United States
(12) Patent Application Publication
(10) Pub. No.: US 2004/0225490 A1
(43) Pub. Date: Nov. 11, 2004

(54) Device for emulating one or more integrated-circuit chips

(75) Inventors: Cesar Douady, Orsay (FR); Philippe Boucard, Le Chesnay (FR)

Correspondence Address: YOUNG & THOMPSON, 745 SOUTH 23RD STREET 2ND FLOOR, ARLINGTON, VA, 22202

(73) Assignee: ARTERIS, PARIS (FR)

(21) Appl. No.: 10/703,491

(22) Filed: Nov. 10, 2003

(30) Foreign Application Priority Data
May 7, 2003 (FR) 03 05538

(51) Int. Cl. G06F 9/455

(52) U.S. Cl. 703/27

(57) ABSTRACT

Device for emulating one or more integrated-circuit chips comprising electronic cards connected together via a communication bus, said electronic cards possessing programmable emulation units. The emulation device includes configurable point-to-point links and, the chip or chips including multisynchronous modules and at least one asynchronous message communication management module, a module is modeled by at most one programmable emulation unit.

### FIELD OF THE INVENTION

The present invention relates to a device for emulating one or more integrated-circuit chips.

The term “emulation” is understood to mean rapid simulation with hardware and software means.

The rapid development in technologies allows ever more logic functions and components to be integrated into an integrated-circuit chip. The components and their connections are ever decreasing in size, which consequently increases the parasitic processes in inter-component connections. This is because, the finer the connections the higher their electrical resistances and their coupling capacitances, and the longer the time delays in transmitting data. These delay problems due to connections become increasingly important with the development of submicron microelectronic technologies. It is therefore becoming increasingly difficult to maintain functional coherence of synchronous subassemblies controlled by the same clock in an integrated-circuit chip. It is also necessary to take account of the desired increase in the growing number of inputs/outputs present on an integrated-circuit chip, while the number of connections via external interfaces is not increasing in the same proportions.

### BACKGROUND OF THE INVENTION

There are in existence devices and methods for simulating and emulating integrated circuits. The logic behavior of integrated circuits is simulated using an appropriate language, for example the language C, VHDL or Verilog, on one or more general purpose machines. An integrated circuit can be emulated using programmable logic circuits, for example FPGAs (field-programmable gate arrays), configured according to the interconnect list or “netlist”, and by exciting these programmable logic circuits so as to check their behavior.

During an emulation, the run speed is substantially higher than a simulation, since the implementation is directly physical and close to the circuit, whereas a simulation uses a representation carried out on the basis of an evolved computing language. A simulation therefore describes the behavior of the circuit using many times the limited resources of one or more processors. The speed of emulation makes it possible to carry out a larger number of tests, larger by a factor of about one thousand, compared with the number of tests carried out by a simulation within the same time.

To produce a machine for emulating integrated circuits, a technology based on programmable logic circuits is used. Now, the description of an integrated circuit to be emulated is generally very complex and requires the use of several programmable logic circuits. This then poses problems of how to divide the circuit into subcircuits of reasonably small size in order for each to be modeled by a single programmable logic circuit. These various programmable logic circuits must communicate with one another so as to recreate the communications between these various subcircuits. This division is generally not easy, and the number of communications between the various subcircuits may be high. This leads to difficulties in constructing such machines, and a high associated cost.

The document accessible at Crossbow's address http://www.crossbowip.com/docs/doc_ppt_pdf/2Dfabric_ope ration_pdf.pdf proposes an emulator based on a division of the circuit into synchronous subcircuits. However, the architecture of this emulator is not reconfigurable.

### SUMMARY OF THE INVENTION

In light of the foregoing, the object of the invention is to transpose an architecture managing the asynchronous communication between synchronous integrated-circuit modules, on a machine so as to emulate, for low cost, integrated circuits designed with this architecture for which the problem of dividing the netlist for an integrated circuit is managed right from the design of the circuit.

Thus, according to one aspect of the invention, what is proposed is a device for emulating one or more integrated-circuit chips, said device comprising electronic cards connected together via a communication bus. Said electronic cards comprise programmable emulation units. The emulation device furthermore comprises configurable point-to-point links. The chip or chips comprise multisynchronous modules and at least one asynchronous message communication management module. A module is modeled by at most one programmable emulation unit. The term “multisynchronous module” is understood to mean a circuit subassembly clock-regulated by one or more clocks dedicated to said module. These multisynchronous modules each comprise a number of components.

This device makes it possible for circuits designed with such an architecture to be emulated for low cost, reducing the problem of the time delays in transmitting data between components that appear with submicron microelectronic technologies. This is because the time delays within a multisynchronous module are controlled, especially since the size of these modules is limited.

In a preferred embodiment, the same predetermined specific protocol is used for the communications between the programmable emulation units that model the modules of the chip or chips, and for the communication between the modules of the chip or chips.

The architecture of the emulation device is then based on the architecture of the circuit to be emulated.

In an advantageous embodiment, the device is coupled to a computer that includes hardware and software means for programming said device with the aim of emulating the integrated-circuit chip or chips, and especially for controlling the programmable emulation units that model the modules of the chip or chips.

In a preferred embodiment, the programmable emulation units are logic circuits programmable by the user.

In an advantageous embodiment, each programmable logic circuit includes one or more associated memories capable of storing the traces of the emulation, so as to deliver information about the behavior of the emulated chip or chips to the user.

In a preferred embodiment, the hardware and software means for programming said device, together with the electronic cards, include means for helping the user configure said device.

This in fact allows the user to be guided, for example when connecting up the connections for the electronic cards, for example by means of electronic indicator lamps on the electronic cards, which lamps are controlled by means of the computer.

In an advantageous embodiment, the device includes means for transmitting data at the same time as their own clock rate information.

One aspect of the predetermined specific protocol, used for the communications between the programmable emulation units, which transmits data at the same time as their own clock rate information, is thus employed.

### BRIEF DESCRIPTION OF THE DRAWINGS

Other objects, features and advantages of the invention will become apparent on reading the following description, given by way of non-limiting example, and with reference to the appended drawings in which:

FIG. 1 is a block diagram of a message communication management device for an integrated-circuit chip;

FIG. 2 is a block diagram of a variant of a communication management device for an integrated-circuit chip;

FIG. 3 is a diagram showing the operation of an asynchronous message communication management module; and

FIG. 4 is a block diagram of a device for emulating an integrated-circuit chip, that includes a communication management device according to one aspect of the invention.

### DESCRIPTION OF PREFERRED EMBODIMENTS

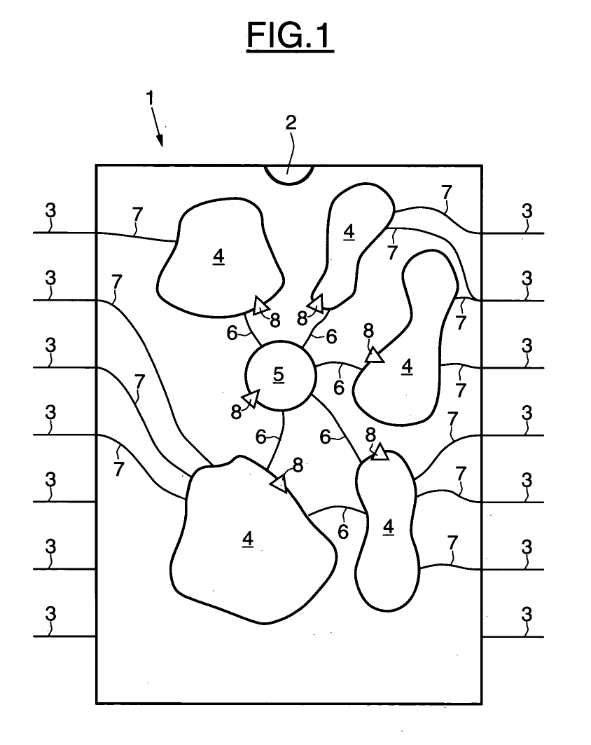

FIG. 1 shows an integrated-circuit chip 1 with an orientation indicator 2, and input/output pins 3 for communication with the outside of said chip 1. The components of the chip 1, of ever increasing number, are grouped together in multisynchronous modules 4. The term “multisynchronous module” is understood to mean a circuit subassembly clock-regulated by one or more clocks dedicated to said module.

An asynchronous message communication management module 5, connected to at least two multisynchronous modules 4, in this case all the multisynchronous modules 4, via point-to-point links 6, manages the communication between the various modules 4 of the integrated-circuit chip 1. The modules 4 communicate with the outside of the chip 1 via links 7 between the modules and input/output pins 3 of the chip 1. Two multisynchronous modules 4 may also, if the design constraints so require, communicate directly via a point-to-point link 6 identical to the point-to-point links 6 between the asynchronous communication management module 5 and each multisynchronous module 4. However, it is preferable for the communications between two synchronous modules 4 to pass via the asynchronous communication management module 5.

An assembly 8 comprising at least one clock dedicated to a single multisynchronous module determines the rate regulation references of the operating frequency of said multisynchronous module 4. It should be noted that the module 5 is one particular case of a multisynchronous module and it also possesses its own assembly 8 comprising at least one clock.

A single specific predetermined communication protocol is used for the communications between said modules of the chip 1 taking place on the links 6.

Each point-to-point link 6 comprises, for each end, message send means and message receive means, each receive means comprising a memory of the first-in first-out type, usually called a “FIFO cell”.

In one link 6, the clock data and the other data are sent simultaneously. As the clock data are being transported, they undergo a phase shift, and the incoming clock data do not have the same phase as the outgoing clock data. The other data then undergo temporal dispersion. If the temporal dispersion is too great, a resynchronization step is carried out.

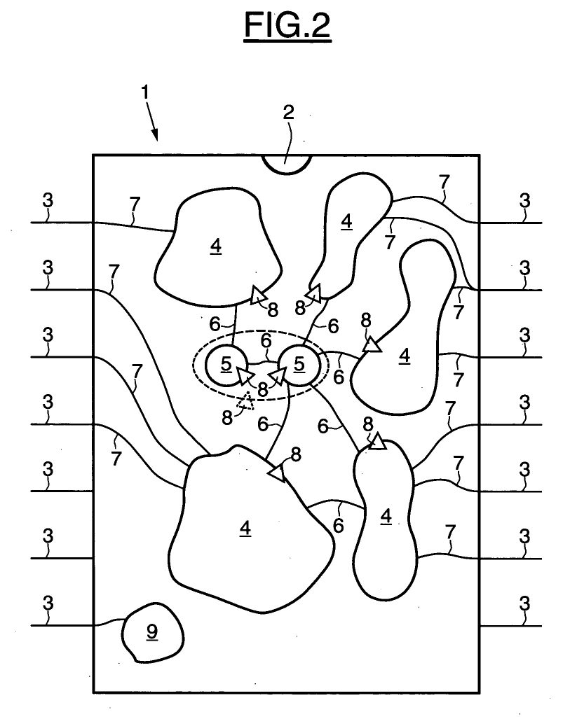

FIG. 2 shows a variant of the device of FIG. 1. The device comprises at least two asynchronous communication management modules 5—here two are shown. It may be necessary, owing to the complexity of a circuit and to its division into a large number of multisynchronous modules, to have several asynchronous communication management modules 5. In addition the circuit may include one or more modules 9, only one of which is shown here, that are not connected to the asynchronous communication management modules 5. This device may be seen from the outside as a single asynchronous communication management module repeating a device similar to that of FIG. 1.

However, there is a difference since the fact of putting several asynchronous communication management modules together requires additional steps for communication between two synchronous modules, especially an additional link 6 for transferring data exchanges, and several successive processing steps corresponding to the number of asynchronous communication management modules.

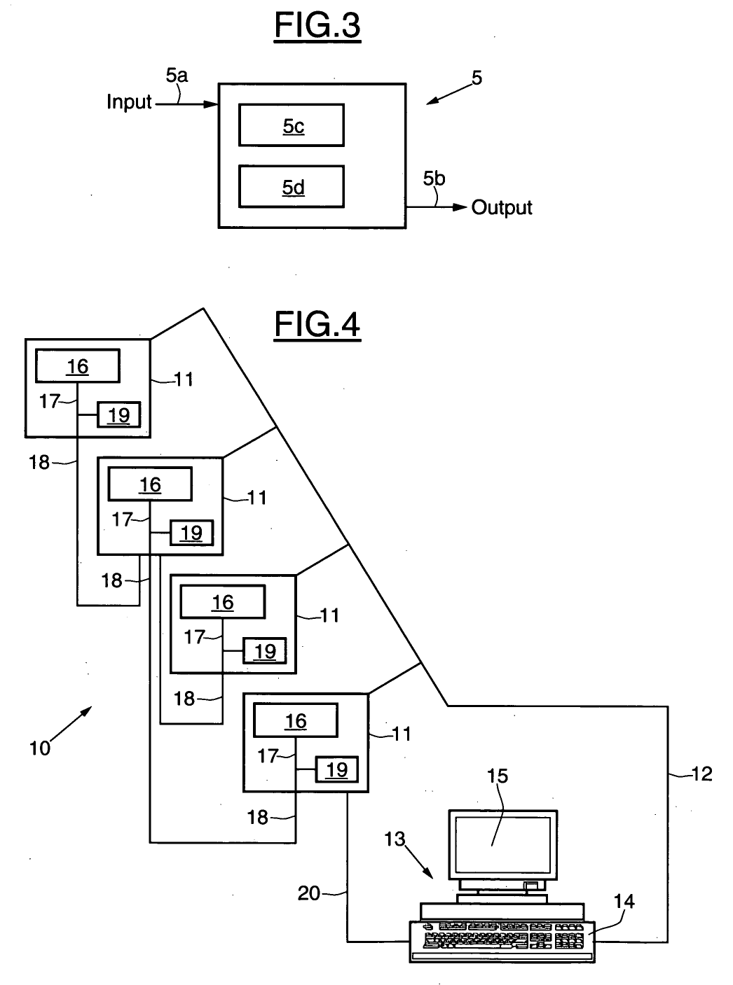

FIG. 3 is a diagram showing the operation of an asynchronous communication management module 5. The latter includes inputs 5a for receiving data messages coming from other modules and outputs 5b for transmitting data messages to other modules. The input messages are stored temporarily, for example in a memory of the first-in first-out type, usually called a “FIFO cell”, of the means for receiving messages from a point-to-point link 6. This temporary storage allows the input messages to be managed, even if these arrive at a rate greater than the message processing capability of the module 5. The asynchronous communication management module 5 furthermore includes means 5c for routing output messages to their intended module, and means 5d for managing the routing of the output messages. An input message is therefore stored in the FIFO cell of the message receive means of a point-to-point link 6 and is then taken into account by the module 5, which will manage its routing to its synchronous destination module 4 via the means 5c and 5d. This message then leaves the module 5 via the output 5b and passes through the means for sending messages from a point-to-point link 6 to the synchronous message destination module.

FIG. 4 shows a device for emulating one or more integrated-circuit chips 1 that have been designed according to the description in FIG. 1.

The emulation device 10 includes a number of electronic cards 11 connected together via a command-and-control communication bus 12 connected to a computer 13. This computer 13 possesses a central processing unit 14 that includes hardware and software means for managing the emulation and for proposing a user friendly interface on a screen 15.

Each electronic card 11 includes at least one programmable logic circuit 16 connected via a link 17 to point-to-point connections 18 configurable by the user. This is because, depending on the circuit to be emulated, said connections 18 connect together electronic cards according to the modeling of the circuit by the programmable logic circuits 16. The connections 18 are the equivalents of the point-to-point links 6 and pass the same messages, and comprise, at each end, the same message send and receive means. Each of the programmable logic circuits furthermore includes an associated memory 19, especially for storing data, usually called traces in the computing field, which may be supplied to the user via the screen 15 of the computer 13. The programmable logic circuits 16 are programmed via a high rate link 20. The link 20 is a link 18 having the particular role of programming the programmable logic circuits 16. The traces will allow the user to study the behavior of the integrated-circuit chip that he has emulated. Advantageously, this information or these traces will be configurable by the user.

The synchronous modules 4 of the chip 1 are each modeled in a single programmable logic circuit 16 of the emulation device 10. Problems associated with the partitionning the circuits to be emulated are thus solved. Likewise, the asynchronous communication management module 5 of said chip 1 is modeled in a single programmable logic circuit 16. In this way, the design architecture of the chip 1 is transposed to the emulation of said chip 1.

In addition, the communication protocol used for the communications between the programmable logic circuits 16 that model the modules 4 and 5 of the chip is the predetermined specific communication protocol used for the communication between the modules of the chip.

The programmable logic circuit 16 that models the asynchronous communication management module 5 then manages the communication between the various programmable logic circuits 16 that model the modules 4 and 5 of the chip 1.

The invention proposes a means of emulating an integrated-circuit chip, by transposing the design architecture of the chip to the architecture of the emulation device. An effective, reconfigurable emulator is therefore obtained, for a greatly reduced cost because of its simplicity, allowing the behavior of an integrated-circuit chip to be emulated. While preferred systems and methods for practicing the present invention have been described above, it is understood that departures may be made from the systems and methods without departing from the scope of the present invention, which is defined by the following claims.

1. A device for emulating one or more integrated-circuit chips, said device comprising electronic cards connected together via a communication bus, said electronic cards possessing programmable emulation units, said emulation device comprising configurable point-to-point links, the chip or chips comprising multisynchronous modules and at least one asynchronous message communication management module, at least a module being modeled by at most one programmable emulation unit.

2. The device as claimed in claim 1, wherein the same predetermined specific protocol is used for the communications between the programmable emulation units that model the modules of the chip or chips, and for the communication between the modules of the chip or chips.

3. The device as claimed in claim 1, wherein said device is coupled to a computer that includes hardware and software means for programming said device with the aim of emulating the integrated-circuit chip or chips, and especially for controlling the programmable emulation units that model the modules of the chip or chips.

4. The device as claimed in claim 2, wherein said device is coupled to a computer that includes hardware and software means for programming said device with the aim of emulating the integrated-circuit chip or chips, and especially for controlling the programmable emulation units that model the modules of the chip or chips.

5. The device as claimed in claim 1, wherein the programmable emulation units are logic circuits programmable by the user.

6. The device as claimed in claim 2, wherein the programmable emulation units are logic circuits programmable by the user.

7. The device as claimed in claim 3, wherein the programmable emulation units are logic circuits programmable by the user.

8. The device as claimed in claim 4, wherein the programmable emulation units are logic circuits programmable by the user.

9. The device as claimed in claim 1, wherein each programmable logic circuit includes one or more associated memories capable of storing traces of the emulation, so as to deliver information about the behavior of the emulated chip or chips to the user.

10. The device as claimed in claim 2, wherein each programmable logic circuit includes one or more associated memories capable of storing traces of the emulation, so as to deliver information about the behavior of the emulated chip or chips to the user.

11. The device as claimed in claim 3, wherein each programmable logic circuit includes one or more associated memories capable of storing traces of the emulation, so as to deliver information about the behavior of the emulated chip or chips to the user.

12. The device as claimed in claim 5, wherein each programmable logic circuit includes one or more associated memories capable of storing traces of the emulation, so as to deliver information about the behavior of the emulated chip or chips to the user.

13. The device as claimed in claim 3, wherein the hardware and software means for programming said device, together with the electronic cards, include means for helping the user configure said device.

14. The device as claimed in claim 5, wherein the hardware and software means for programming said device, together with the electronic cards, include means for helping the user configure said device.

15. The device as claimed in claim 8, wherein the hardware and software means for programming said device, together with the electronic cards, include means for helping the user configure said device.

16. The device as claimed in claim 1, which includes means for transmitting data at the same time as their own clock rate information.

17. The device as claimed in claim 2, which includes means for transmitting data at the same time as their own clock rate information.

18. The device as claimed in claim 3, which includes means for transmitting data at the same time as their own clock rate information.

19. The device as claimed in claim 5, which includes means for transmitting data at the same time as their own clock rate information.

20. The device as claimed in claim 8, which includes means for transmitting data at the same time as their own clock rate information.
